(19) United States
(12) Patent Application Publication
(10) Pub. No.: US 2022/0292347 A1
(43) Pub. Date: Sep. 15, 2022

(54) METHOD AND APPARATUS FOR PROCESSING INFORMATION

(71) Applicants: BEIJING XIAOMI MOBILE SOFTWARE CO., LTD., Beijing (CN); Beijing Xiaomi Pinecone Electronics Co., Ltd., Beijing (CN)

(72) Inventor: Yuhui SUN, Beijing (CN)

(73) Assignees: BEIJING XIAOMI MOBILE SOFTWARE CO., LTD., Beijing (CN); Beijing Xiaomi Pinecone Electronics Co., Ltd., Beijing (CN)

(21) Appl. No.: 17/491,305

(22) Filed: Sep. 30, 2021

(30) Foreign Application Priority Data
Mar. 15, 2021 (CN) 202110277986.7

(51) Int. Cl. G06N 3/08; G06K 9/62

(52) U.S. Cl. CPC G06N 3/08; G06K 9/6228; G06K 9/6298

(57) ABSTRACT

The present disclosure relates to a method and an apparatus for processing information. The method comprises: acquiring to-be-processed information, and taking the to-be-processed information as an input of a processing model acquired by training a preset model so as to acquire target information corresponding to the to-be-processed information and output by the processing model. The preset model includes a plurality of operation modules and normalization structure corresponding to each of the plurality of operation modules, the normalization structure is configured to normalize an output of the corresponding operation module, and the processing model is acquired by removing a specified number of normalization structures according to a target probability or the number of steps for training the preset model in the process of training the preset model.

### CROSS REFERENCE TO RELATED APPLICATION

The application claims priority to Chinese Patent Application No. 202110277986.7 filed on Mar. 15, 2021, the entire content of which is incorporated herein by reference.

### TECHNICAL FIELD

The present disclosure relates to the technical field of deep learning, and in particular to a method and an apparatus for processing information.

### BACKGROUND

With development of a deep learning technology, a deep learning model is widely used in a plurality of technical fields such as natural language processing, image processing and data mining. In the deep learning model, output of a module included in the model can be normalized by setting a corresponding normalization structure so as to improve an effect of model training. However, in a model prediction phase, the normalization structure prolongs the delay of model prediction. In order to shorten the delay of model prediction, the normalization structure in the deep learning model needs to be removed during model training.

### SUMMARY

The present disclosure provides a method and an apparatus for processing information.

According to a first aspect of the present disclosure, a method for processing information comprises: acquiring to-be-processed information, wherein the to-be-processed information includes at least one of text information and image information; and taking the to-be-processed information as an input of a processing model to acquire target information that is corresponding to the to-be-processed information and is output by the processing model The processing model is acquired by training a preset model, and the target information may reflect specified features included in the to-be-processed information. The preset model includes a plurality of operation modules and normalization structure corresponding to each of the plurality of operation modules, and the normalization structure is configured to normalize an output of the corresponding operation module; and the processing model is acquired by removing a specified number of normalization structures according to a target probability or the number of steps for training the preset model in the process of training the preset model.

According to a second aspect of the present disclosure, an electronic device is provided, and the electronic device includes: a processor; and a memory configured to store executable instructions of the processor. The processor is configured to operate the executable instructions so as to implement steps of the method for processing information, including: acquiring to-be-processed information, wherein the to-be-processed information includes at least one of text information and image information; and taking the to-be-processed information as an input of a processing model to acquire target information that is corresponding to the to-be-processed information and is output by the processing model The processing model is acquired by training a preset model, and the target information may reflect specified features included in the to-be-processed information. The preset model includes a plurality of operation modules and normalization structure corresponding to each of the plurality of operation modules, and the normalization structure is configured to normalize an output of the corresponding operation module; and the processing model is acquired by removing a specified number of normalization structures according to a target probability or the number of steps for training the preset model in the process of training the preset model.

According to a third aspect of the present disclosure, a non-transitory computer readable storage medium stores computer program instructions thereon. The program instructions, when executed by a processor, implement steps of the method for processing information, including: acquiring to-be-processed information, wherein the to-be-processed information includes at least one of text information and image information; and taking the to-be-processed information as an input of a processing model to acquire target information that is corresponding to the to-be-processed information and is output by the processing model The processing model is acquired by training a preset model, and the target information may reflect specified features included in the to-be-processed information. The preset model includes a plurality of operation modules and normalization structure corresponding to each of the plurality of operation modules, and the normalization structure is configured to normalize an output of the corresponding operation module; and the processing model is acquired by removing a specified number of normalization structures according to a target probability or the number of steps for training the preset model in the process of training the preset model.

It should be understood that the above general descriptions and the following detailed descriptions are exemplary and explanatory only, and are not intended to limit the disclosure.

### BRIEF DESCRIPTION OF THE DRAWINGS

The accompanying drawings, which are incorporated in and constitute a part of this specification, illustrate examples consistent with the disclosure and together with the specification serve to explain the principles of the disclosure.

FIG. 1 is a flow chart illustrating a method for processing information according to one or more examples of the present disclosure.

FIG. 2 is a flow chart illustrating a method for training processing model according to one or more examples of the present disclosure.

FIG. 3 is a flow chart of step 202 according to the example shown in FIG. 2.

FIG. 4 is a block diagram illustrating an apparatus for processing information according to one or more examples of the present disclosure.

FIG. 5 is a block diagram illustrating an electronic device according to one or more examples of the present disclosure.

### DETAILED DESCRIPTION

Embodiments will be described in detail herein, examples of which are illustrated in the accompanying drawings. When the following description refers to the accompanying drawings, the same numbers in different drawings represent the same or similar elements unless otherwise indicated. The implementations described in the following exemplary embodiments do not represent all implementations consistent with the disclosure. On the contrary, they are merely examples of an apparatus and a method consistent with some aspects of the disclosure as detailed in the appended claims.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

Before describing a method and an apparatus for processing information provided by the present disclosure, application scenarios related to various examples of the present disclosure are first described. The application scenarios may be scenarios in which a preset model provided with normalization structures is trained to acquire a processing model. After to-be-processed information is input into the processing model, the processing model may output target information corresponding to the to-be-processed information according to the learned inherent law and the representation level of training data. In the model prediction phase, the normalization structures may prolong the delay of model prediction. In order to shorten the delay of model prediction, the normalization structures in the preset model need to be removed in the training process.

In the related art, when a preset model starts to be trained, the normalization structures in the preset model may be removed by adjusting initialization, scaling and biasing operations, and the normalization structures in the preset model may also be removed by adding a learnable parameter before residual connection or in each item of residual connection included in the preset model. However, the above methods are all based on proof derivation, the proof derivation is in fact incomplete, and there are problems that it cannot be reproduced practically and the training of the preset model is unstable. In addition, even if training of the preset model can be completed, the quality of a processing model acquired after removing the normalization structures in the preset model is poor, which affects the accuracy of target information output by the processing model.

If the normalization structure in the deep learning model is removed in a training process, the stability of model training may be influenced, even the model cannot be normally trained, the quality of the trained model is poor, and the accuracy of information output by the model is reduced.

In order to solve the problems in the related art, a specified number of normalization structures in a preset model are gradually removed according to a target probability or a number of training steps so as to acquire a processing model, so that the training of the preset model is not interfered, the training stability of the preset model is high, the quality of the processing model can be ensured, and the accuracy of the target information is improved.

FIG. 1 is a flow chart illustrating a method for processing information according to an example of the present disclosure. As shown in FIG. 1, the method may comprise the following steps.

In step 101, to-be-processed information is acquired, wherein the to-be-processed information includes at least one of text information and image information.

In step 102, the to-be-processed information is taken as an input of a processing model acquired by training a preset model so as to acquire target information corresponding to the to-be-processed information and output by the processing model, wherein the target information may reflect specified features included in the to-be-processed information.

The preset model includes a plurality of operation modules and normalization structure corresponding to each of the plurality of operation modules, the normalization structure is configured to normalize an output of the corresponding operation module, and the processing model is acquired by removing a specified number of normalization structures according to a target probability or the number of steps for training the preset model in the process of training the preset model.

For example, in the technical fields of natural language processing, image processing and the like, generally, the preset model including the plurality of operation modules and normalization structure corresponding to each of the plurality of operation modules needs to be set according to actual applications, and the preset model is trained to acquire the required processing model. Each normalization structure is configured to normalize the output of the corresponding operation module, so that the output of the operation module obeys standard Gaussian distribution, training of the preset model is stable, a higher learning rate is realized, the model convergence is accelerated, and the generalization capability is improved. The normalization process may be, for example, Layer Normalization (LN) operations, Batch Normalization (BN) operations, Weight Normalization (WN) operations, etc. which is not specifically limited in the present disclosure. For example, in the scenarios like machine translation, dialogue, Artificial Intelligence (AI) creation, and knowledge map construction in the field of natural language processing, the preset model may be a deep learning model (or a BERT model) with a Transformer structure, the normalization process may adopt LN operations, and then the normalization structures are LN structures. As another example, in the field of image processing, the normalization process may adopt BN operations, and then the normalization structures are BN structures.

In order to ensure the quality of the processing model while removing the specified number of normalization structures in the preset model, the preset model may be gradually adapted to the process without the normalization structures based on the idea that the normalization structures in the preset model are gradually removed from simplicity to difficulty when the preset model is trained. For example, the preset model is trained to converge under the condition that all the normalization structures are reserved, then some of the normalization structures are removed according to the target probability (the target probability may be, for example, 0.2), the preset model is trained to converge, then the target probability may be increased, the above steps are repeated until the specified number of normalization structures are removed according to the target probability, and the preset model with the specified number of normalization structures removed is trained to converge so as to acquire the processing model. For another example, the number of normalization structures to be removed may be gradually increased as the number of the steps for training the preset model increases until the specified number of normalization structures are removed, and the processing model is acquired. The preset model is trained according to the above approach, the training process is simple, the reliability and the universality are high, the accuracy of the processing model can be ensured, and the processing model acquired by removing the specified number of normalization structures achieves the effect of having the same quality as a processing model acquired by not removing the normalization structures.

Further, after the processing model is acquired, the to-be-processed information may be acquired and input into the processing model to acquire the target information output by the processing model. The to-be-processed information may only include the text information or the image information, and may also include both the text information and the image information. The target information may reflect the specified features included in the to-be-processed information. For example, when the processing model is applied to a machine translation scenario and the to-be-processed information only includes the text information, the to-be-processed information may be a to-be-translated text, and the target information may be a target text after the to-be-translated text is translated.

In summary, according to the present disclosure, the to-be-processed information is acquired and taken as the input of the processing model acquired by training the preset model so as to acquire the target information corresponding to the to-be-processed information and output by the processing model, wherein the to-be-processed information includes at least one of text information and image information, the target information may reflect the specified features included in the to-be-processed information, the preset model includes the plurality of operation modules and normalization structure corresponding to each of the plurality of operation modules, the normalization structure is configured to normalize the output of the corresponding operation module, and the processing model is acquired by removing the specified number of normalization structures according to the target probability or the number of the steps for training the preset model in the process of training the preset model. The specified number of normalization structures in the preset model are gradually removed according to the target probability or the number of the steps for training the preset model so as to acquire the processing model, so that the training of the preset model cannot be interfered, the training stability of the preset model is high, the quality of the processing model can be ensured, and the accuracy of the target information is improved.

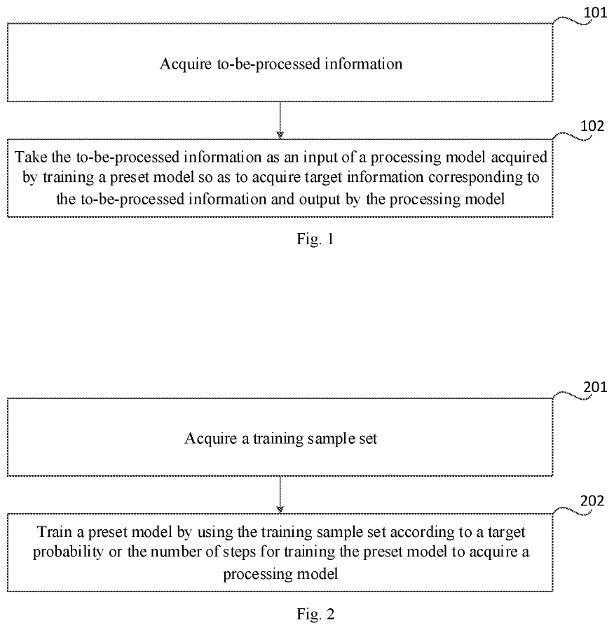

FIG. 2 is a flow chart illustrating a method for training processing model according to an example of the present disclosure. As shown in FIG. 2, the processing model is trained in the following manner.

In step 201, a training sample set is acquired.

The training sample set includes a plurality of groups of training data, each group of training data includes: input end training data and corresponding output end training data, the input end training data includes first training information, and the output end training data includes second training information corresponding to the first training information.

In step 202, the preset model is trained by using the training sample set according to the target probability or the number of steps for training the preset model to acquire the processing model.

In some embodiments, when the preset model is trained, the training sample set including the plurality of groups of training data can be obtained firstly, wherein each group of training data consists of the input end training data including the first training information and the output end training data including the second training information. For example, when the processing model is applied in the machine translation scenario, the first training information may be a training text and the second training information may be a text after the training text is translated. Then, according to the target probability or the number of the steps for training the preset model, the whole data of the training sample set are adopted to perform multiple times of complete training (i.e. training of a plurality of Epochs) on the preset model so as to acquire the processing model. Each group of training data may be understood as a Batch of data divided from the training sample set. The training process of the preset model may be completed on a terminal or a server, for example, the preset model may be trained on a graphics processing unit (GPU) of the server.

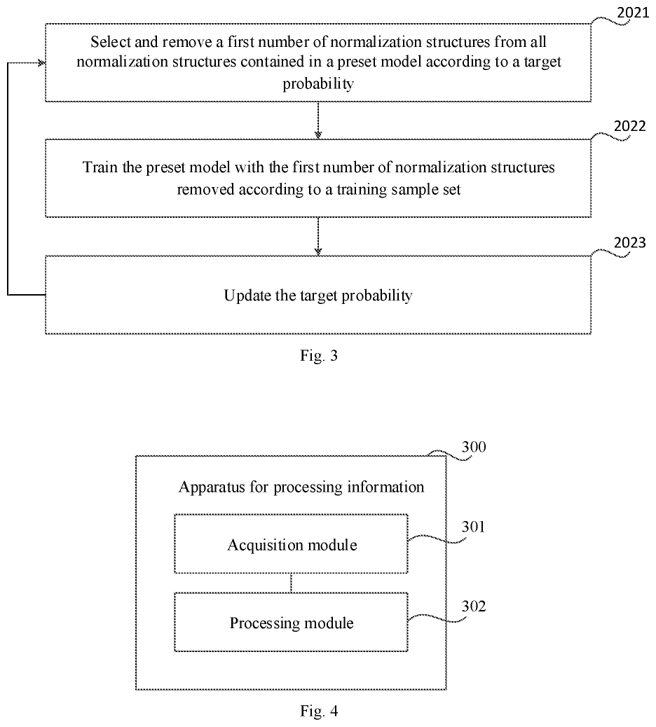

FIG. 3 is a flow chart of step 202 according to the example shown in FIG. 2. As shown in FIG. 3, step 202 may include the following steps.

In step 2021, a first number of normalization structures are selected and removed from all the normalization structures contained in the preset model according to the target probability.

In step 2022, the preset model with the first number of normalization structures removed is trained according to the training sample set.

In one scenario, firstly the preset model may be trained to converge under the condition that all the normalization structures are reserved. Then, in each step for training the preset model according to the training sample set, a first number of normalization structures are randomly selected and removed from all the normalization structures included in the preset model according to the target probability until the preset model is trained to converge, so that the generalization capability of the preset model is enhanced, the model convergence is accelerated, and the preset model does not depend on the normalization structures as much as possible. For example, when the preset model includes five normalization structures, if the target probability p is 0.2, then the first number is 5×0.2=1, one normalization structure is removed, namely the normalization processing corresponding to this normalization structure is skipped in the process of training the preset model. It should be noted that in each step for training the preset model, the first number of normalization structures removed may be different. The condition for training the preset model to converge may be as follows: a loss function of the preset model is stabilized in a preset interval, so that fluctuation of the loss function is small.

In step 2023, the target probability is updated, wherein the updated target probability is greater than the target probability before updating.

The steps 2021 to 2023 are repeatedly executed until the specified number of normalization structures are removed so as to acquire the processing model.

Further, the target probability may be updated according to a preset proportionality coefficient so as to be increased, namely the first number is increased. For example, in the case where the proportionality coefficient is 2, if the target probability is 0.2, the updated target probability is 0.4, at the moment, the process of updating the target probability can be expressed using p′=2p, wherein p′ is the updated target probability and p is the target probability before updating. Or, the target probability may be updated according to a preset function, which may be, for example, any function capable of increasing the target probability, which is not specifically limited in the present disclosure.

Then, the above steps may be repeatedly executed until the specified number of normalization structures are removed according to the target probability, and the preset model after the specified number of normalization structures are removed is trained to converge to acquire the processing model. The specified number may be set according to a preset probability threshold value, and if the target probability is greater than or equal to the probability threshold value, the specified number of normalization structures are removed when the preset model is trained. For example, when all of the normalization structures need to be removed, the probability threshold value may be set to 1, and if the target probability is greater than or equal to 1, all the normalization structures in the preset model are removed.

It should be noted that by training the preset model to converge according to each target probability, the accuracy of the trained processing model can be ensured. In addition, the step-by-step increase process of the target probability may be understood as a process in which the preset model firstly learns relatively simple standard Gaussian distribution with the assistance of the normalization structures, and then gradually removes the assistance of the normalization structures to learn distribution with high difficulty.

In some embodiments, step 202 may be implemented in the following manner: the preset model is trained through a preset training step according to the training sample set and the number of the steps for training the preset model until the specified number of normalization structures are removed so as to acquire the processing model.

In another scenario, the preset model may be trained through the preset training steps according to the training sample set and the number of the steps for training the preset model, so that the number of the normalization structures to be removed is gradually increased along with the increase of the number of the steps for training the preset model until the specified number of normalization structures are removed to acquire the processing model. The preset training step may include the following steps: firstly, when the number of the steps for training the preset model according to the training sample set is N, a target variance is determined according to N, wherein N is a natural number. For example, the target variance may be determined by a first formula, wherein the first formula may be, for example, var=\sqrt{N}, and var is the target variance. Then for each operation module, whether to remove the normalization structure corresponding to the operation module may be determined based on a current variance output by the operation module (i.e., the variance output by the operation module when the number of the steps for training is N) and the target variance. The manner in which the variance output by each operation module is calculated may be referred to description in the related art, which will not be described in detail in the present disclosure.

If the variance output by the operation module is less than or equal to the target variance, the normalization structure corresponding to the operation module is removed. If the variance output by the operation module is greater than the target variance, the normalization structure corresponding to the operation module is reserved. Through the above-described approach, when the number of the steps for training the preset model is small, the target variance is small, and more normalization structures may be reserved. As the number of the steps for training the preset model increases, the target variance gradually increases, more and more normalization structures are removed until the specified number of normalization structures are removed, and the processing model is acquired.

In some embodiments, the preset model includes an encoder and a decoder, the encoder is composed of a second number of operation modules, the decoder is composed of a third number of operation modules, and the operation modules are attention networks or feedforward neural networks.

For example, when the preset model is a deep learning model using a Transformer structure, the preset model may include the encoder and the decoder, the encoder includes a second number of operation layers, and each operation layer of the encoder consists of an attention network executing Multi-Head Attention operations and a feedforward neural network. The decoder includes a third number of operation layers, and each operation layer of the decoder consists of an attention network executing Masked Multi-Head Attenuation operations, an attention network executing Multi-Head Attenuation operations and a feedforward neural network. Each operation module (attention network or feedforward neural network) corresponds to one normalization structure respectively, then each operation layer of the encoder corresponds to two normalization structures, and each operation layer of the decoder corresponds to three normalization structures, wherein the second number and the third number may be the same or different, which is not specifically limited in the present disclosure.

FIG. 4 is a block diagram illustrating an apparatus for processing information according to an example of the present disclosure. As shown in FIG. 4, the apparatus for processing information 300 comprises an acquisition module 301 and a processing module 302.

The acquisition module 301 is configured to acquire to-be-processed information, wherein the to-be-processed information includes at least one of text information and image information.

The processing module 302 is configured to take the to-be-processed information as an input of a processing model acquired by training a preset model so as to acquire target information corresponding to the to-be-processed information and output by the processing model, wherein the target information may reflect specified features included in the to-be-processed information.

The preset model includes a plurality of operation modules and normalization structure corresponding to each of the plurality of operation modules, and the normalization structure is configured to normalize an output of the corresponding operation module; and the processing model is acquired by removing a specified number of normalization structures according to a target probability or the number of steps for training the preset model in the process of training the preset model.

In some embodiments, the processing module 302 is configured to train the processing module in the following manner: a training sample set is acquired, wherein the training sample set includes a plurality of groups of training data, each group of training data includes input end training data and corresponding output end training data, the input end training data includes first training information, and the output end training data includes second training information corresponding to the first training information; and the preset model is trained by using the training sample set according to the target probability or the number of the steps for training the preset model to acquire the processing model.

In some embodiments, the processing module 302 is configured to select and remove a first number of normalization structures from all the normalization structures contained in the preset model according to the target probability; train the preset model with the first number of normalization structures removed according to the training sample set; update the target probability, wherein the updated target probability is greater than the target probability before updating; and repeatedly execute steps of selecting and removing the first number of normalization structures from all the normalization structures contained in the preset model according to the target probability to updating the target probability until the specified number of normalization structures are removed, so as to acquire the processing model.

In some embodiments, the processing module 302 is configured to update the target probability according to a preset proportionality coefficient; or update the target probability according to a preset function.

In some embodiments, the processing module 302 is configured to train the preset model through a preset training step according to the training sample set and the number of the steps for training the preset model until the specified number of normalization structures are removed so as to acquire the processing model.

In some embodiments, the preset training step includes when the number of the steps for training the preset model according to the training sample set is N, a target variance is determined according to N, wherein N is a natural number; whether to remove the normalization structure corresponding to the operation module is determined according to a variance output by each current operation module and the target variance; for each operation module, whether to remove the normalization structure corresponding to the operation module is determined based on a current variance output by the operation module and the target variance; if the variance output by the operation module is less than or equal to the target variance, the normalization structure corresponding to the operation module is removed; and if the variance output by the operation module is greater than the target variance, the normalization structure corresponding to the operation module is reserved.

In some embodiments, the preset model includes an encoder and a decoder, the encoder is composed of a second number of operation modules, the decoder is composed of a third number of operation modules, and the operation modules are attention networks or feedforward neural networks.

With regard to the apparatus in the above-described example, the specific manner in which the various modules perform operations has been described in detail in the examples of the method, which will not be described in detail herein.

In summary, the specified number of normalization structures in the preset model are gradually removed according to the target probability or the number of the steps for training the preset model so as to acquire the processing model, so that the training of the preset model is not interfered, the training stability of the preset model is high, the quality of the processing model can be ensured, and the accuracy of the target information is improved.

The present disclosure further provides a computer readable storage medium, which stores computer program instructions thereon; and the program instructions, when executed by a processor, implement the steps of the method for processing information provided by the present disclosure.

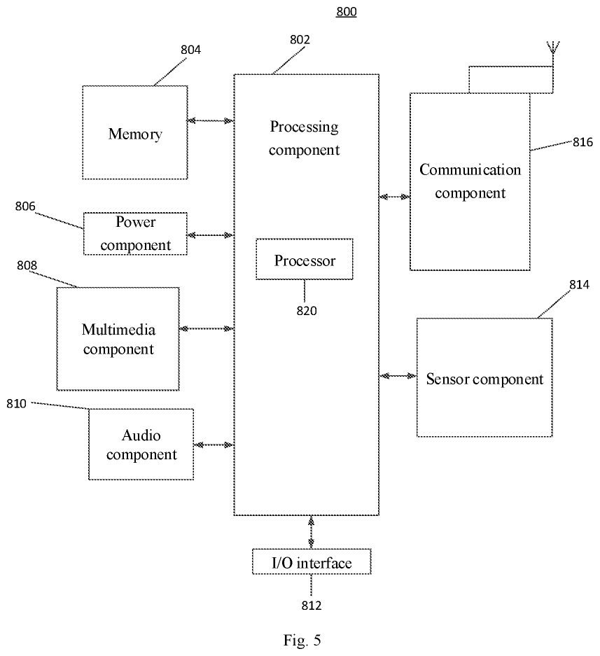

FIG. 5 is a block diagram illustrating electronic device 800 according to an example of the present disclosure. For example, the electronic device 800 may be a mobile phone, a computer, a digital broadcast terminal, a messaging device, a gaming console, a tablet, a medical device, exercise equipment, a personal digital assistant and the like.

Referring to FIG. 5, the electronic device 800 may comprise one or more components as follows: a processing component 802, a memory 804, a power component 806, a multimedia component 808, an audio component 810, an Input/Output (I/O) interface 812, a sensor component 814 and a communication component 816.

The processing component 802 typically controls overall operations of the electronic device 800, such as operations associated with display, telephone calls, data communications, camera operations and recording operations. The processing component 802 may comprise one or a plurality of processors 820 to execute instructions to complete all or part of the steps of the method for processing information described above. In addition, the processing component 802 may comprise one or a plurality of modules to facilitate the interaction between the processing component 802 and other components. For example, the processing component 802 may comprise a multimedia module to facilitate the interaction between the multimedia component 808 and the processing component 802.

The memory 804 is configured to store various data to support operations at the electronic device 800. Examples of such data comprise instructions for any applications or methods operated on the electronic device 800, contact data, phonebook data, messages, pictures, video, etc. The memory 804 may be implemented by any type of volatile or non-volatile memory devices or combinations thereof, such as a Static Random Access Memory (SRAM), an Electrically Erasable Programmable Read Only Memory (EEPROM), an Erasable Programmable Read Only Memory (EPROM), a Programmable Read Only Memory (PROM), a Read Only Memory (ROM), a magnetic memory, a flash memory, a magnetic disk or a compact disk.

The power component 806 provides power to various components of the electronic device 800. The power component 806 may comprise a power management system, one or more power sources, and any other components associated with the generation, management and distribution of power for the electronic device 800.

The multimedia component 808 comprises a screen providing an output interface between the electronic device 800 and a user. In some examples, the screen may comprise a liquid crystal display (LCD) and a touch panel (TP). If the screen comprises the TP, the screen may be implemented as a touch screen to receive an input signal from a user. The touch panel comprises one or more touch sensors to sense touch, swiping, and gestures on the touch panel. The touch sensors may not only sense a boundary of a touch or swipe action, but also detect duration and pressure related to the touch or swipe operation. In some examples, the multimedia component 808 comprises a front camera and/or a rear camera. The front camera and/or the rear camera may receive external multimedia data when the electronic device 800 is in an operation mode, such as a photographing mode or a video mode. Each front camera and each rear camera may be fixed optical lens systems or may have focal lengths and optical zoom capabilities.

The audio component 810 is configured to output and/or input audio signals. For example, the audio component 810 comprises a Microphone (MIC) configured to receive an external audio signal when the electronic device 800 is in an operation mode, such as a call mode, a recording mode and a voice recognition mode. The received audio signals may be further stored in the memory 804 or sent via the communication component 816. In some examples, the audio component 810 further comprises a speaker configured to output audio signals.

The I/O interface 812 provides an interface between the processing component 802 and peripheral interface modules, such as a keyboard, a click wheel, buttons and the like. These buttons may include, but not limited to: a home button, a volume button, a start button and a lock button.

The sensor component 814 comprises one or more sensors configured to provide status assessments of various aspects of the electronic device 800. For example, the sensor component 814 may detect an opened/closed state of the electronic device 800 and the relative positioning of the components such as a display and a keypad of the electronic device 800, and the sensor component 814 may also detect the position change of the electronic device 800 or a component of the electronic device 800, the presence or absence of contact between a user and the electronic device 800, the orientation or acceleration/deceleration of the electronic device 800 and the temperature change of the electronic device 800. The sensor component 814 may comprise a proximity sensor configured to detect the existence of nearby objects under the situation of no physical contact. The sensor component 814 may also comprise an optical sensor, such as a CMOS or CCD image sensor, for use in an imaging application. In some examples, the sensor component 814 may further comprise an acceleration sensor, a gyroscope sensor, a magnetic sensor, a pressure sensor or a temperature sensor.

The communication component 816 is configured to facilitate wired or wireless communication between the electronic device 800 and other devices. The electronic device 800 may access to a wireless network based on a communication standard, such as WiFi, 2G or 3G, or combinations thereof. In one example, the communication component 816 receives broadcast signals or broadcast related information from an external broadcast management system via a broadcast channel. In one example, the communication component 816 further comprises a Near Field Communication (NFC) module to facilitate short-range communications. For example, the NFC module can be implemented based on a Radio Frequency Identification (RFID) technology, an Infrared Data Association (IrDA) technology, an Ultra-Wideband (UWB) technology, a Bluetooth (BT) technology and other technologies.

In some examples, the electronic device 800 may be implemented with one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic elements, for executing the above-described method for processing information.

In some examples, a non-transitory computer readable storage medium including instructions is further provided, such as the memory 804 including the instructions, executable by the processor 820 in the electronic device 800, for completing the above-described method for processing information. For example, the non-transitory computer readable storage medium may be a Read Only Memory (ROM), a Random Access Memory (RAM), a Compact Disc Read Only Memory (CD-ROM), a magnetic tape, a floppy disk, an optical data storage device and the like.

In another example, a computer program product is further provided and comprises a computer program executable by a programmable device, and the computer program has code portions configured to execute the above-described method for processing information when executed by the programmable device.

In summary, the specified number of normalization structures in the preset model are gradually removed according to the target probability or the number of the steps for training the preset model so as to acquire the processing model, so that the training of the preset model is not interfered, the training stability of the preset model is high, the quality of the processing model can be ensured, and the accuracy of target information is improved.

According to a first aspect of the present disclosure, a method for processing information comprises: acquiring to-be-processed information, wherein the to-be-processed information includes at least one of text information and image information; and taking the to-be-processed information as an input of a processing model acquired by training a preset model so as to acquire target information corresponding to the to-be-processed information and output by the processing model, wherein the target information may reflect specified features included in the to-be-processed information; wherein the preset model includes a plurality of operation modules and normalization structure corresponding to each of the plurality of operation modules, and the normalization structure is configured to normalize an output of the corresponding operation module; and the processing model is acquired by removing a specified number of normalization structures according to a target probability or the number of steps for training the preset model in the process of training the preset model.

According to a second aspect of the present disclosure, an apparatus for processing information comprises: an acquisition module, configured to acquire to-be-processed information, wherein the to-be-processed information includes at least one of text information and image information; and a processing module, configured to take the to-be-processed information as an input of a processing model acquired by training a preset model so as to acquire target information corresponding to the to-be-processed information and output by the processing model, wherein the target information may reflect specified features included in the to-be-processed information; wherein the preset model includes a plurality of operation modules and normalization structure corresponding to each of the plurality of operation modules, and the normalization structure is configured to normalize an output of the corresponding operation module; and the processing model is acquired by removing a specified number of normalization structures according to a target probability or a number of steps for training the preset model in the process of training the preset model.

According to a third aspect of the present disclosure, an electronic device comprises: a processor; and a memory configured to store executable instructions of the processor. The processor is configured to operate the executable instructions so as to implement steps of the method for processing information provided by the first aspect of the present disclosure.

According to a fourth aspect of the present disclosure, a non-transitory computer readable storage medium stores computer program instructions thereon. The program instructions, when executed by a processor, implement steps of the method for processing information provided by the first aspect of the present disclosure.

The technical solution provided by the examples of the present disclosure may include the following beneficial effects: the specified number of normalization structures in the preset model are gradually removed according to the target probability or the number of steps for training the preset model so as to acquire the processing model, so that training of the preset model cannot be interfered, the training stability of the preset model is high, the quality of the processing model can be ensured, and the accuracy of the target information is improved.

Other implementation solutions of the present disclosure will be apparent to those skilled in the art from consideration of the specification and practice of the disclosure herein. The application is intended to cover any variations, uses or adaptations of the disclosure following the general principles thereof and including such departures from the disclosure as come within known or customary practice in the art. It is intended that the specification and examples be considered as exemplary only, with a true scope and spirit of the present disclosure being indicated by the appended claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

What is claimed is:

1. A method for processing information, comprising:
acquiring to-be-processed information, wherein the to-be-processed information comprises at least one of text information and image information; and
taking the to-be-processed information as an input of a processing model to acquire target information that is corresponding to the to-be-processed information and is output by the processing model, wherein the processing model is acquired by training a preset model, and the target information reflects specified features comprised in the to-be-processed information; wherein
the preset model comprises a plurality of operation modules and normalization structure corresponding to each of the plurality of operation modules, and the normalization structure is configured to normalize an output of the corresponding operation module; and the processing model is acquired by removing a specified number of normalization structures according to a target probability or a number of steps for training the preset model in a process of training the preset model.

2. The method according to claim 1, wherein training the preset model to acquire the processing model further comprises:
acquiring a training sample set, wherein the training sample set comprises a plurality of groups of training data, each group of training data comprises: input end training data and corresponding output end training data, the input end training data comprises first training information, and the output end training data comprises second training information corresponding to the first training information; and
training the preset model by using the training sample set according to the target probability or the number of the steps for training the preset model to acquire the processing model.

3. The method according to claim 2, wherein training the preset model by using the training sample set according to the target probability or the number of the steps for training the preset model to acquire the processing model further comprises:
selecting and removing a first number of normalization structures from all the normalization structures comprised in the preset model according to the target probability;
training the preset model with the first number of normalization structures removed according to the training sample set;
updating the target probability, wherein the updated target probability is greater than the target probability before updating; and
repeatedly executing steps of selecting and removing the first number of normalization structures from all the normalization structures comprised in the preset model according to the target probability to updating the target probability until the specified number of normalization structures are removed, so as to acquire the processing model.

4. The method according to claim 3, wherein updating the target probability further comprises:
updating the target probability according to a preset proportionality coefficient; or
updating the target probability according to a preset function.

5. The method according to claim 2, wherein training the preset model by using the training sample set according to the target probability or the number of the steps for training the preset model to acquire the processing model further comprises:
training the preset model through a preset training step according to the training sample set and the number of the steps for training the preset model until the specified number of normalization structures are removed to acquire the processing model.

6. The method according to claim 5, wherein the preset training step comprises:
in response to determining that the number of the steps for training the preset model according to the training sample set is N, determining a target variance according to N, wherein N is a natural number;
for each operation module, determining whether to remove the normalization structure corresponding to the operation module according to a current variance output by the current operation module and the target variance; if the variance output by the operation module is less than or equal to the target variance, removing the normalization structure corresponding to the operation module;
and if the variance output by the operation module is greater than the target variance, reserving the normalization structure corresponding to the operation module.

7. The method according to claim 1, wherein the preset model comprises an encoder and a decoder, the encoder comprises a second number of operation modules, and the decoder comprises a third number of operation modules; and the operation modules comprise attention networks or feedforward neural networks.

8. An electronic device, comprising:
a processor; and
a memory configured to store executable instructions of the processor; wherein
the processor is configured to operate the executable instructions so as to implement a method for processing information comprising:
acquiring to-be-processed information, wherein the to-be-processed information comprises at least one of text information and image information; and
taking the to-be-processed information as an input of a processing model to acquire target information that is corresponding to the to-be-processed information and is output by the processing model, wherein the processing model is acquired by training a preset model, and the target information reflects specified features comprised in the to-be-processed information; wherein
the preset model comprises a plurality of operation modules and normalization structure corresponding to each of the plurality of operation modules, and the normalization structure is configured to normalize an output of the corresponding operation module; and the processing model is acquired by removing a specified number of normalization structures according to a target probability or a number of steps for training the preset model in a process of training the preset model.

9. The electronic device according to claim 8, wherein the processor is configured to acquire the processing model by training the preset model in a following manner:
acquiring a training sample set, wherein the training sample set comprises a plurality of groups of training data, each group of training data comprises: input end training data and corresponding output end training data, the input end training data comprises first training information, and the output end training data comprises second training information corresponding to the first training information; and
training the preset model by using the training sample set according to the target probability or the number of the steps for training the preset model to acquire the processing model.

10. The electronic device according to claim 9, wherein the processor is configured to train the preset model by:
selecting and removing a first number of normalization structures from all the normalization structures comprised in the preset model according to the target probability;
training the preset model with the first number of normalization structures removed according to the training sample set;
updating the target probability, wherein the updated target probability is greater than the target probability before updating; and
repeatedly executing steps of selecting and removing the first number of normalization structures from all the normalization structures comprised in the preset model according to the target probability to updating the target probability until the specified number of normalization structures are removed, so as to acquire the processing model.

11. The electronic device according to claim 10, wherein the processor is configured to update the target probability by:
updating the target probability according to a preset proportionality coefficient; or
updating the target probability according to a preset function.

12. The electronic device according to claim 9, wherein the processor is configured to train the preset model by:
training the preset model through a preset training step according to the training sample set and the number of the steps for training the preset model until the specified number of normalization structures are removed to acquire the processing model.

13. The electronic device according to claim 12, wherein the preset training step comprises:
in response to determining that the number of the steps for training the preset model according to the training sample set is N, determining a target variance according to N, wherein N is a natural number;
for each operation module, determining whether to remove the normalization structure corresponding to the operation module according to a current variance output by the current operation module and the target variance; if the variance output by the operation module is less than or equal to the target variance, removing the normalization structure corresponding to the operation module; and if the variance output by the operation module is greater than the target variance, reserving the normalization structure corresponding to the operation module.

14. The electronic device according to claim 8, wherein the preset model comprises an encoder and a decoder, the encoder comprises a second number of operation modules, and the decoder comprises a third number of operation modules; and the operation modules comprise attention networks or feedforward neural networks.

15. A non-transitory computer readable storage medium, storing computer program instructions thereon, wherein the program instructions, when executed by a processor, implement a method for processing information comprising:
acquiring to-be-processed information, wherein the to-be-processed information comprises at least one of text information and image information; and
taking the to-be-processed information as an input of a processing model to acquire target information that is corresponding to the to-be-processed information and is output by the processing model, wherein the processing model is acquired by training a preset model, and the target information reflects specified features contained in the to-be-processed information; wherein
the preset model comprises a plurality of operation modules and normalization structure corresponding to each of the plurality of operation modules, and the normalization structure is configured to normalize an output of the corresponding operation module; and the processing model is acquired by removing a specified number of normalization structures according to a target probability or a number of steps for training the preset model in a process of training the preset model.
